(19) United States
(12) Patent Application Publication
(10) Pub. No.: US 2011/0068915 A1
(43) Pub. Date: Mar. 24, 2011

(54) GEOCODED ALERT SYSTEM

(75) Inventor: Howard John WAKEFIELD, III, Houston, TX (US)

(73) Assignee: ThinAir Wireless, Inc., Houston, TX (US)

(21) Appl. No.: 12/565,608

(22) Filed: Sep. 23, 2009

(51) Int. Cl. G08B 1/08; G08B 21/00

(52) U.S. Cl. 340/539.13; 340/686.1

(57) ABSTRACT

A method and memory for a geocoded alert system are disclosed. The method includes the steps of obtaining an alert from an information database, determining an applicable geographic area of the alert, acquiring a geographic location from a communication device, geocoding the geographic location into a geocoded location, storing the geocoded location in a data store, retrieving the geocoded location from the data store when the alert is obtained, ascertaining whether the geocoded location matches the applicable geographic area of the alert, sending a message to the communication device of the user, and confirming a preference of the user to receive the alert.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to alert systems. Specifically, the present invention relates to alert systems that transmit information based on geographic parameters of the alert. More specifically, the present invention relates to alert systems that transmit information to users based on geographic locations of the users.

2. Description of Related Art

Alert systems are commonly used to alert people of various events. An alert system typically has an event monitor that monitors conditions indicative of an event. Upon the occurrence of the event, the event monitor sends a signal to the alert system. The alert system then processes the signal and sends a communication to a user of the alert system. A common alert system is the home security system. In the home security system, motion sensors are placed throughout a home so as to detect a movement of a thing or person. If the motion sensors detect a movement, a signal (usually electronic) is sent to a system controller. Upon receipt of the signal, the system controller typically activates an audible alarm.

A common problem with alert systems is that one must be near the phone or home in order to receive a message about the alert. A message regarding the alert can be delivered when a person is not near the phone or home, and the person may not receive the message until it is too late to effectively react to the message. For example, if the burglar alarm of a home is activated and the homeowner is on vacation, a burglar can easily escape because the homeowner did not receive the message. If the homeowner were to receive the message on a mobile device, then the homeowner could immediately react, such as by calling the police. Thus, there is a need to immediately communicate alerts to people regardless of the user's geographic location.

Global positioning systems (GPS) are increasingly associated with numerous mobile devices. The GPS provided by the United States is a satellite navigation system that has a space segment, a control segment, and a user segment. Space vehicles (SV), i.e. space satellites, are used in the space segment. Each SV sends radio signals from space. There are many SVs orbiting the earth, and four are needed to compute a position. The control segment consists of control and tracking stations that are located around the world. The control segment controls the accuracy of the SVs. The user segment consists of GPS receivers and the users of such receivers. GPS receivers are included in many devices, such as mobile phones and other mobile devices. The GPS receiver receives the signals from the SVs and determines the geographic position of the device. Various other data can be calculated by the receiver, such as time and velocity. GPS receivers are increasingly incorporated into mobile devices; thus, GPS can be used to determine the location of the mobile device. The mobile devices can be configured to send wireless signals that communicate the position of the mobile device. In mobile communication devices, such as a mobile phone, the user of the mobile phone can instantly obtain his or her position using a GPS receiver.

When traveling from location to location, a person can be unknowingly exposed to many dangers, such as a chemical plant explosion, a fire, a tornado, an earthquake, and a major traffic accident. The time for reaction to these events is minimal and many people often encounter such events unexpectedly. Thus, there is a need for an alert system with the capability to alert people of sudden events that can account for the geographic location of people and the geographic area of the event.

Various patents have issued relating to GPS alert systems and methods. For example, U.S. Pat. No. 7,126,454, issued to Bulmer on Oct. 24, 2006, discloses a system for alerting the public regarding a criminal act. The system has law enforcements nodes that generate alerts related to a criminal or emergency issue and transmit the same to a central server. A central server system includes an administration workstation and database for receiving the alerts and creating broadcast messages. A broadcast system is associated with the central server for broadcasting an alert via a televised broadcast, internet transmission or satellite transmission.

U.S. Pat. No. 7,362,852, issued to Rodkey, et al. on Apr. 22, 2008, discloses a school-wide notification and response system utilizing an administrator interface to transmit a message from an administrator to contact devices for parents, employees, and students associated with a school. The system includes an interface with a translator, a “call me” feature, and a “call in” feature that enable a customer service representative to use the system to send a message to users. The system has a dynamic information database that includes parent, employee, and student contact data, priority information, and response data. The administrator initiates distribution of the message based upon grouping information, priority information, and the priority order. The message is transmitted through at least two industry-standard gateways simultaneously to selected group contact devices based upon priority information. Once the message is received by the contact devices, the contact devices then transmit a response through the industry standard gateways back to the dynamic information database.

U.S. Pat. No. 7,130,389, issued to Rodkey, et al. on Oct. 31, 2006, discloses a digital notification and response system that utilizes an administrator interface to transmit a message from an administrator to a user-contact device. The system has a dynamic information database that includes user-contact data, priority information, and response data. The administrator initiates distribution of the message based upon grouping information, priority information, and the priority order. The message is transmitted through at least two industry-standard gateways simultaneously to groups of user-contact devices based upon priority information. Once the message is received by the user contact device, the user contact device transmits a response through the industry standard gateways back to the dynamic information database.

U.S. Pat. No. 7,180,415, issued to Bankert, et al. on Feb. 20, 2007, discloses a safety/security system that has a central-control station and remote stations suitable for installation in residential and business buildings. The central-control station receives public emergency warnings, notifications, and advisories, and transmits alert messages to select remote stations based on geographic or other criteria. Each remote station includes an identifier, a visual display, a user interface, and electronics for receiving the alert message from the central control center, for processing the alert message to determine if the remote station is an intended recipient of the message by ascertaining if the alert message includes the remote station identifier, and, if the remote station is an intended recipient of the alert message, for utilizing the display to display information related to the alert message.

U.S. Pat. No. 6,453,051, issued to Mason, et al. on Apr. 1, 2003, discloses a system for inputting conventional emergency alert messages into a digital subscriber television system. The method allows existing emergency alert equipment to interface with the digital system equipment in the head-end of a digital subscriber television system. A unique identifier and the format of the digital emergency alert message allow the input of an emergency alert message and allow for a wide variety of optional data formats, system control options, and data storage options.

U.S. Pat. Nos. 7,531,850 and 7,046,140, issued to Adamczyk, et al. on Mar. 25, 2008, disclose a method of alerting a person to a situation. An alert signal is received from a mobile communication device in signal communication with a wireless communication system and an alert system. In response to the alert signal, a database of an alert service is accessed for information relating to the subscriber of the mobile communication device and for information relating to a contact list associated with the subscriber. Information is obtained from the wireless communication system relating to the location of the subscriber, and a communication is made to a member of the subscriber's contact list providing information relating to the subscriber and the situation.

U.S. Pat. No. 7,518,506, issued to Lee, et al. on Apr. 14, 2009, discloses a security system that electrically communicates with a user device, especially via an e-mail transmitted over the internet. A security system interface receives a signal indicating an occurrence of an event, such as a fault or alarm condition, in a zone of the security system. A memory stores a user e-mail address associated with the security system and an address of a server. The server provides internet service, such as an ISP server. An e-mail generator transmits to the server an e-mail message based on the event. The communication node in such a system may be integrated with the control panel of the security system. The e-mail generator can transmit the e-mail using SMTP or other TCP/IP. An attachment of the e-mail, such as a picture or an audio or video file relevant to the event or the zone may be transmitted.

U.S. Pat. No. 7,091,852, issued to Mason, et al. on Aug. 15, 2006, discloses an emergency response personnel automated accountability system, also referred to as a Firefighter Automated Accountability System (FAAS). The FAAS supports automatic tracking of, and limited communications among, first responders including fire fighters, police offices, emergency medical personnel, and safety personnel. The FAAS increases situational awareness and safety of first-responder personnel by automatically providing position information as well as other sensor information. Components of the FAAS integrate wireless mesh networks with positioning and communication systems to support real-time tracking of and communications with emergency response personnel. The FAAS incident awareness system provides position and time information via Global Positioning System (GPS) and/or other positioning systems, and processed data from sensors to provide enhanced communications, command, and control capabilities to the first responders and incident command at the incident scene.

U.S. Pat. No. 7,423,538, issued to Gonzalez on Sep. 9, 2008, discloses a child alert system that uses radio transmitters and receivers to provide the location of a child, adult or object to which a transmitter unit of the system is attached. The transmitter unit includes a panic button for allowing the wearer of the transmitter unit to send a panic signal when they feel endangered. The system further includes signaling when the transmitter is submerged, when the vital signs of the wearer fall below a certain threshold, or when the transmitter is tampered or removed from the person.

U.S. Pat. No. 7,310,533, issued to Galetti on Dec. 18, 2007, discloses a method for a communication system that includes the steps of generating a message inquiry signal, and sending the message inquiry signal to a base station to determine if updated command messages are available from the base station. When updated command messages are available from the base station, the updated command messages are transmitted to the device. The device may then operate a text display using the updated command messages.

U.S. Pat. No. 6,879,962, issued to Smith, et al. on Apr. 12, 2005, discloses a logistics method that provides logistics computer programming for controlling transports to supply delivery locations from one or more bases. Each of the bases and delivery locations are in communication with a central database (preferably an Internet server database) that contains updated logistics information. The central database is preferably automatically updated at selectable intervals as to transport location, destination, fuel level, speed, and heading. Manifests may be originated at the respective delivery location or at an associated base and are stored in the central database. Each material on the manifest is associated with information such as the authorized vendor, a description, storage preferences, units, hazardous designations, and additional information if the material is hazardous. Given information about each transport such load capacity, fuel level, location intelligence, and the like that is stored in the central database, and given information about materials, manifest status, and other factors, potential least cost delivery routes using capable transports can be automatically produced for selection by an operator. The logistics computer programming automatically designates where each manifested material is stored on the transport. The computer programming associates a status designation with each manifest such as outstanding, stages, printed, loaded, unloaded, and canceled. Each manifest is also associated with a priority which may range from emergency to routine. Updated logistics information concerning materials, manifests, vendors, transports, delivery locations, and operating companies is available from the central database.

U.S. Pat. No. 6,611,686, issued to Smith, et al. on Aug. 26, 2003, discloses a system, apparatus, and method for monitoring, tracking, and other logistics purposes that preferably includes a monitoring unit wherein data is processed using a microcontroller. The monitoring unit includes an interface with the target or asset to be tracked such that electrical signals may be sent between the target and monitoring unit to denote events from the target, e.g., air bag deployment and for activating features of the target, e.g., an alarm. The interface may be unique for each monitoring unit because unique information relating to each interface is stored in the system database, e.g., data may be related to a temperature in one unit and to a movement sensor indication in another. Therefore, the system may respond appropriately to signals having unique meanings from each different monitoring unit. A pager unit with a pager modem is controlled by the microcontroller to thereby encode the signals for transmission. A pager transmitter/receiver network is used for sending and receiving messages from the monitoring unit. The pager transmitter/receiver network is in communication with a server and the database. The server may be accessed by multiple clients over the Internet or other lines of communication so that the clients at numerous different remote locations may activate controls on their respective one or more remote targets/assets, find the locations thereof, and receive cumulative status reports.

Various patent applications have been published relating GPS alert systems and methods. For example, U.S. Patent Application Publication No. 2007/0,139,189, published to Helmig on Jun. 21, 2007, discloses a method, computer program product, and system for receiving a data signal from a transmitting device. The data signal is processed to determine if the data signal is a device data signal or a personal data signal. If the data signal is a device data signal, the device data signal is routed to a device monitoring system. If the data signal is a personal data signal, the personal data signal is routed to a personal monitoring system. The transmitting device can include a GPS receiver.

U.S. Patent Application Publication No. 2005/0,219,044, published to Douglass, et al. on Oct. 6, 2005, discloses a software system and associated method that implements real-time management of events such as emergencies, contingencies, and incidents by responding to user inputs and environmental detectors, carrying out defined and custom procedures, establishing communications channels with key personnel and emergency services, maintaining an audit trail of events, broadcasting appropriate instructions, tasks, and graphical information to personnel, and providing monitoring, recording, and communication facilities for local and/or remote coordinators and command centers.

U.S. Patent Application Publication No. 2008/0,088,437, published to Aninye, et al. on Apr. 17, 2008, discloses a monitoring system where alarm information and location data from a wireless personal tracking device carried by an individual is transmitted to an administrative hub for processing and action according to defined rules, including dispatching optimum assistance in the event of an alarm. Simultaneous monitoring of individuals with diverse tracking units and effective event recording and reporting can be implemented.

U.S. Patent Application Publication No. 2009/0,134,982, published to Robertson, et al. on May 28, 2009, discloses a system and method for providing an alert notification. A computer-readable storage medium according to one embodiment has instructions for configuring an alert text, configuring at least one audible alert instruction, and configuring at least one visible alert instruction. The computer-readable storage medium also has instructions for constructing an alert notification, and delivering the alert notification to at least one intended recipient device. The alert notification message includes the alert text, the audible alert instruction, and the visible alert instruction.

U.S. Patent Application Publication No. 2007/0,038,360, published to Sakhpara on Feb. 15, 2007, discloses a system that includes a network server and mobile devices that communicate with the network server. Each mobile device is associated with a vehicle and is configured to provide Global Positioning System (GPS) parameters to the network server. The network server uses the GPS parameters to detect traffic congestion in a zone.

It is an object to send communications upon the occurrence of an alert.

It is another object to customize communication of alerts based on geographic area of the alert.

It is another object to customize communication of alerts based on geographic location of a receiver of the alert.

It is another object to provide an alert system where users can select which alert communications to receive.

It is still another object to provide an alert system where users can decide how to receive an alert communication.

It is another object to send messages regarding alerts to a communication device, such as a mobile phone, a personal computer, a pager, a telephone, etc.

It is another object to send messages by voice, video, SMS, streaming video, text-to-voice, and email.

It is another object to utilize a GPS associated with a communication device.

It is another object to immediately alert people upon the occurrence of an alert.

The objects and advantages of the invention are not limited to those disclosed above. These objects and advantages are made apparent by the specification and claims.

### SUMMARY OF THE INVENTION

A method for a geocoded alert system is described herein. The geocoded alert system has a memory associated therewith.

The method includes the steps of obtaining an alert from an information database, determining an applicable geographic area of the alert, acquiring a geographic location from a communication device, geocoding the geographic location into a geocoded location, ascertaining whether the geocoded location matches the applicable geographic area of the alert, sending a message to the communication device, confirming a preference to receive the alert, storing the geocoded location in a data store of the geocoded alert system, and retrieving the geocoded location from the data store when the alert is obtained. The communication device has a global positioning system associated therewith. The step of acquiring includes contacting the communication device, establishing the geographic location of the global positioning system of the communication device, and returning the geographic location from the communication device. The step of ascertaining includes geocoding the applicable geographic area of the alert into a geocoded area, and determining whether the geocoded location matches the geocoded area. The step of sending includes transmitting the message to the communication device of the user when the applicable geographic area of the alert matches the geographic location of the user. The step of transmitting includes transmitting the message to the communication device of the user when the alert is a preferred alert. The step of obtaining includes scanning the information database for the alert, and retrieving the alert from the information database. Alternatively, the step of obtaining includes receiving the alert from the information database.

The method alternatively includes the steps of obtaining an alert from an information database, determining an applicable geographic area of the alert, entering a geographic location by the user, geocoding the geographic location into a geocoded location, ascertaining whether the geocoded location matches the applicable geographic area of the alert, sending a message to a communication device of the user, and confirming a preference to receive the alert. The step of ascertaining includes geocoding the applicable geographic area of the alert into a geocoded area, and determining whether the geocoded location matches the geocoded area. The step of sending includes transmitting the message to the communication device of the user when the geocoded area matches the geocoded location. The step of sending further includes transmitting the message to the communication device of the user when the alert is a preferred alert.

The memory comprises an alert unit, a locating unit, a geocoding unit, an analyzing unit, a sending unit, and a preference unit. The alert unit obtains an alert that has an applicable geographic area. The locating unit obtains a geographic location of a communication device. The geocoding unit geocodes the applicable geographic area into a geocoded area. The geocoding unit also geocodes the geographic location into a geocoded location. The analyzing unit determines whether the geocoded location matches the geocoded area. The sending unit sends a message to a communication device when the geocoded location matches the geocoded area. The preference unit determines whether the alert is a preferred alert. When using the preference unit, the sending unit sends the message only if the alert is the preferred alert.

### BRIEF DESCRIPTION OF THE SEVERAL VIEWS OF THE DRAWINGS

FIG. 1 shows a data flow diagram illustrating the flow of data in the geocoded alert system of the invention.

FIG. 2 shows a block diagram of a memory for the geocoded alert system.

FIG. 3 shows an exemplary embodiment of the device of the geocoded alert system.

FIG. 4 shows a flow diagram for the method of alerting users of the geocoded alert system.

FIG. 5 shows a flow diagram for the step of ascertaining.

FIG. 6 shows a flow diagram for one embodiment of the step of obtaining.

FIG. 7 shows a flow diagram for another embodiment of the step of obtaining.

FIG. 8 shows a flow diagram for the step of sending.

FIG. 9 shows a flow diagram for an alternative method of alerting users of the geocoded alert system.

FIG. 10 shows a user interface for the preference unit.

### DETAILED DESCRIPTION OF THE PREFERRED EMBODIMENT(S)

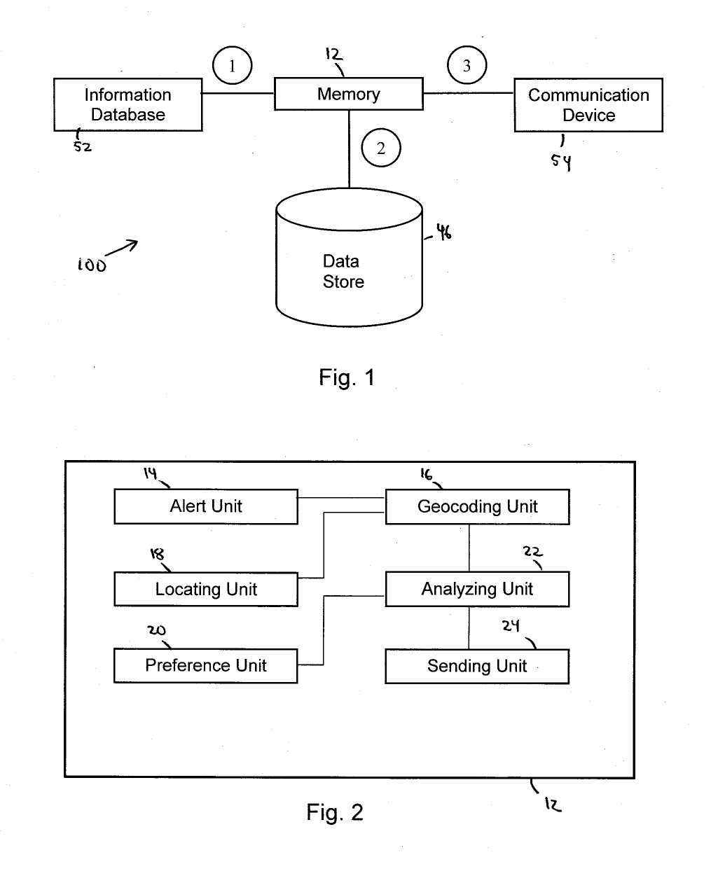

Referring to FIG. 1, there is shown a data flow diagram illustrating the flow of data in the geocoded alert system 100 of the invention. The flow of data in the geocoded alert system 100 is described in four general stages. In stage 1, data of an alert flows from an information database 52 to the memory 12 of the system 100. The information database 52 can be any sort of database or system that has geo-specific alerts available for the system 100 to obtain. An example of an information database 52 is a government database for tornado alerts. The term “alert” as used herein means information or data that identifies an event. The alert data flows from the information database 52 to the memory 12. The memory 12 contains software for manipulating the alert, as is described in more detail in FIG. 2 below.

In stage 2, data flows between the data store 46 and the memory 12 of the system 100. Data such as geographic locations and geocoded locations can flow from memory 12 to the data store 46. These data can likewise flow from the data store 46 to the memory 12. In stage 3, data flows from the memory 12 to a communication device 54. The communication device 54 can be any device that delivers a message of the alert to a user of the system 100, such as a mobile phone, a personal computer, a television, a telephone, a pager, etc. The communication device 54 communicates a message of the system 100 by voice, email, text-to-voice, SMS, video images (e.g. streaming video), audio sounds, other similar methods of communication. The communication device 54 can have a global positioning system (GPS). For example, the communication device 54 can be a mobile phone with GPS capabilities.

Referring to FIG. 2, there is shown a block diagram of a memory 12 used in the geocoded alert system 100 of the invention. The memory 12 stores data and/or instructions temporarily and/or permanently, and may comprise any suitable memory, such as random access memory (RAM) or a hard drive. The embodiment of the memory 12 shown in FIG. 2 has an alert unit 14, a geocoding unit 16, a locating unit 18, a preference unit 20, an analyzing unit 22, and a sending unit 24. These units 14, 16, 18, 20, 22, and 24 are exemplary of the desired functions of the memory 12. Thus, the invention contemplates that units in the memory 12 can be combined or subdivided into other units so as to perform these specific functions.

The alert unit 14 obtains an alert and determines the applicable geographic area of the alert. The applicable geographic area is geocoded in the geocoding unit 16. The locating unit 18 acquires a geographic location of a user of the system 100. To acquire the geographic location, the locating unit 18 can contact the communication device 54 of the user, or the user can manually enter the geographic location into the system 100. The geographic location of the user is geocoded in the geocoding unit 16.

The preference unit 20 confirms preferences of a user of the system 100 to receive a given alert. For example, if a user of the system 100 chooses to receive alerts about child kidnappings but not about tornadoes, then the preference unit 20 accounts for the user's preference to receive a child kidnapping alert but not a tornado alert. The analyzing unit 22 ascertains whether a geocoded location of a user matches a geocoded area of an alert. If the geocoded location of the user matches the geocoded area of the alert, and if the alert is a preferred alert of the user, then the sending unit sends a message regarding the alert to a user of the system 100. The preference unit 20 can confirm preferences of a user of the system 20 at any point in the process of geocoded alert system 100. For example, the preference unit 20 could confirm that an alert is a preferred alert when the memory 12 receives the alert, or the preference unit 20 could confirm that the alert is a preferred alert after the analyzing unit 22 ascertains that the geocoded area matches the geocoded location. The line connections between the units 14-24 of the memory 12 are shown as exemplary paths for the flow of data. These paths may be altered or changed according to different combinations or subdivisions of the units 14-24 and according to different orders of steps of the method 101 described below.

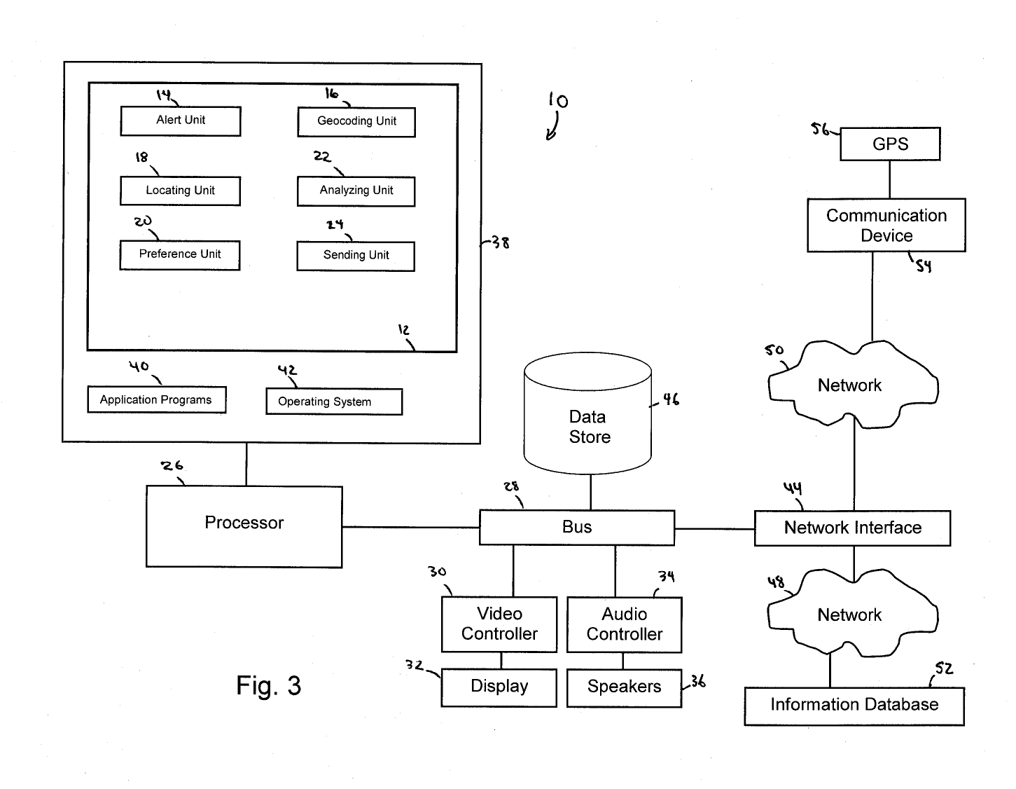

Referring to FIG. 3, there is shown an exemplary embodiment of the device 10 of the geocoded alert system 100. The device 10 has system memory 38. Application programs 40, an operating system 42, and the memory 12 are included in the system memory 38. The processor 26 executes the various units 14, 16, 18, 20, 22, and 24 of the memory 12 as well as application programs 40 and the operating system 42. The processor 26 is electrically coupled to the memory 12. The processor 26 electrically couples the system memory 38 with the bus 28. A video controller 30 and audio controller 34 are electrically coupled to the bus 28. A display 32 is electrically coupled to the video controller 30 so that an administrator of the system 100 can view images associated with the operation of the system 100. Speakers 36 are electrically coupled to the audio controller 34 so an administrator of the system 100 can hear any sounds associated with the operation of the system 100. The data store 46 is electrically coupled to the bus 28. Data manipulated by the memory 12 can be stored in the data store 46. A network interface 44 couples the device 10 to any number of necessary networks 48 and 50. Networks 48 and 50 can be any network, such as the Internet, an Intranet, a wireless network for mobile phones, a government database network, etc. The system 100 accesses or receives alerts from the information database 52 through network 48. For example, the system 100 can access or receive specific locations of sex offenders from a directory of such offenders. The system 100 acquires geographic locations and sends messages to the communication device 54 through network 50. The network 50 can be a wireless network through which the system 100 communicates with the communication device 54. The communication device 54 can have a GPS associated therewith for determining the geographic location of the device 54. The user of the system 100 can have multiple communication devices 54. The geographic location can be the location of any of the communication devices 54 of the user of the system 100, such as the user's mobile phone with GPS capabilities or the user's home computer. Thus, a user of the system 100 can have a home computer and a mobile phone with GPS associated with the system 100. If the geographic location of the user's mobile phone is geocoded, and the geocoded location matches the geocoded area, then an alert message can be sent to the mobile phone as well as the home computer of the user. One of skill in the art would know how to electrically couple of the components of the device 10 and how to connect the device 10 to various networks.

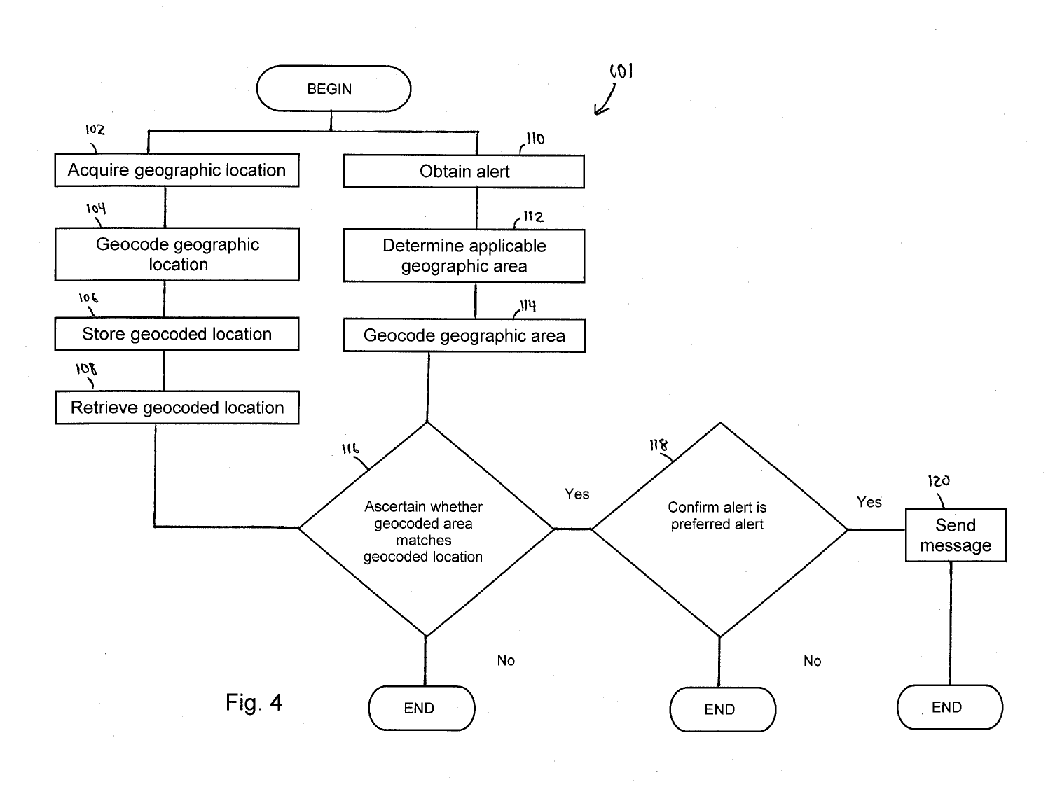

The method 101 of the invention is discussed in FIGS. 4 through 8 below. The exemplary embodiments of the system 100, memory 12, and device 10 shown in FIGS. 1 through 3, respectively, are used to describe the exemplary embodiment of the method 101.

Referring to FIG. 4, there is shown a flow diagram for the method 101 of the geocoded alert system 100. The method 101 shows the exemplary operations of the geocoded alert system 100 by which users of the system 100 are sent messages regarding alerts based on the geographic location of the user and the geographic area of the alert. The method begins at process blocks 102 and 110. That is, data for the system is obtained and acquired in two parallel series of steps that merge in decision block 116.

The first series of steps of the method 101 beings at process block 102, where the system 100 acquires a geographic location from a communication device 54 of the user of the system 100. In the exemplary embodiment of the memory 12, the locating unit 18 acquires the geographic location. When the communication device 54 has a GPS associated therewith, the GPS of the communication device 54 provides the geographic location. The geographic location is a physical location such as an address, district, town, county, region, country, etc. The flow continues to process block 104.

At process block 104, the memory 12 geocodes the geographic location into a geocoded location. The geocoded location is a coded representation of the physical longitude and latitude coordinates of the communication device 54 of the user of the system 100. Geocoding is performed by the geocoding unit 16 of the memory 12, which is generally a piece of software that assigns geographic coordinates in latitude and longitude to a given location. Multiple coordinates can be used to define a location. With geographic coordinates assigned, the geocoded location allows the system 100 to quickly compare the code of the geographic location with the geographic area, discussed below. The flow continues to process block 106.

At process block 106, the geocoded location of the geographic location is stored in the data store 46. The data store 46 can be permanent memory, such as a hard drive, or temporary memory, such as random access memory. The data store 46 is designed to integrate data from various sources to facilitate analysis thereof. The locating unit 18 of the memory 12 can store the geographic location in the data store 46. The flow continues to process block 108.

At process block 108, the geocoded location is retrieved from the data store 46 once an alert is obtained. Thus, the system 100 allows for the immediate storage in the data store 46 of the geocoded location for later retrieval once a relevant alert is obtained from an information database 52. The geocoding unit 16 or the analyzing unit 22 of the memory can retrieve the geocoded location from the data store 46. Although not shown in FIG. 4, the system 100 can immediately store the geographic location (that is not geocoded) in the data store 46 and retrieve the geographic location for geocoding once a relevant alert is obtained. The locating unit 18 or the geocoding unit 16 of the memory 12 can retrieve the geographic location from the data store 46 for geocoding thereof. In another alternative, the system 100 can simply store both the geographic location and the geocoded location. Once the geocoded location is retrieved in process block 108, the flow continues to decision block 116.

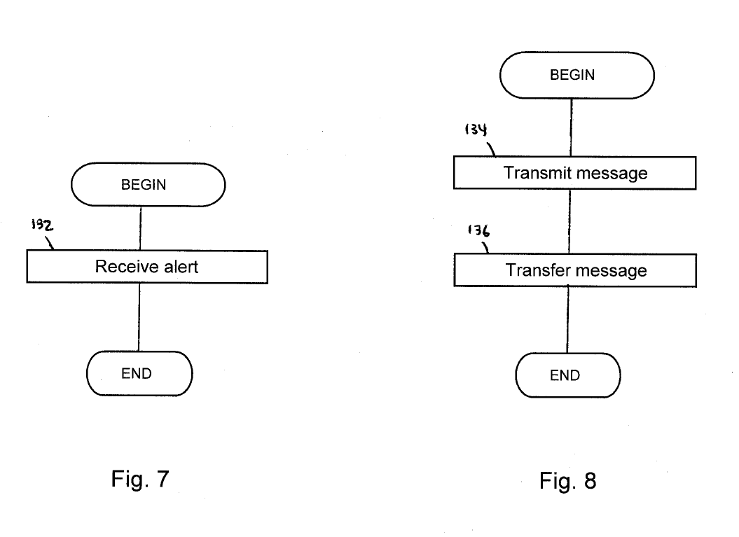

The second series of steps of method 101 begins with process block 110. At process block 110, an alert is obtained from an information database 52. The alert unit 14 of memory 12 accesses the information database 52 through a network 48, such as the Internet. The alert is typically in the form of data that can be recognized and manipulated by the memory 12. The alert has a notification component that contains information regarding the nature of the alert and a geographic component that contains information regarding the applicable geographic area of the alert. For example, the notification component contains information that the alert pertains to a chemical plant explosion. The geographic component of the alert contains information identifying the geographic areas affected by the chemical plant explosion. The geographic areas are the physical locations applicable to the alert, such an address, district, town, county, region, country, etc. In this chemical plant explosion example, if wind conditions change causing a change in the applicable geographic areas, then a new alert can be obtained and the content of the new applicable geographic areas can be processed by the system 100 for quick messaging of users of the system. The alert can be obtained in different ways, as is described in FIGS. 6-7 below. The flow continues to process block 112.

At process block 112, the system 100 determines the applicable geographic area of the alert. The term “geographic area” applies to any size of a geographic area, such as a specific longitude-and-latitude position or a large span of land and/or ocean spanning large distances that can be identified by multiple longitude and latitude positions. Thus, the system 100 determines which physical locations are included in the geographic component of the alert. The flow continues to process block 114.

At process block 114, the system 100 geocodes the applicable geographic area of the alert into a geocoded area. Geocoding of the applicable geographic area is performed by the geocoding unit 16 of the memory 12, which is generally a piece of software that assigns geographic coordinates in latitude and longitude to a given area. Multiple coordinates can be used to define a geocoded area. With geographic coordinates assigned, the geocoded area allows the system 100 to quickly compare the code of the geographic area with the code of the geographic location. The flow continues to decision block 116.

At decision block 116, the system 100 determines whether the geocoded area of the alert matches the geocoded location of the communication device 54. This step of the method 101 can be performed by the analyzing unit 22 of the memory. The geocoded area may or may not match the geocoded location. To match, the geocoded area can be the geocoded location or the geocoded area can encompass the geocoded location. That is, one of the coordinates of the alert geocoded by the geocoding unit 16 matches one of the coordinates of the geographic location of the communication device 54 geocoded by the geocoding unit 16. In this case, the flow continues to decision block 118. If there is no match, none of the coordinates of the geocoded area match any of the coordinates of the geocoded location. In this case, the method 101 ends because the alert does not apply to the geographic location of the communication device 54 of the user of the system 100.

At decision block 118, the system 100 confirms that the alert is a preferred alert designated by the user of the system 100. This step of the method 101 can be performed by the preference unit 20 of the memory 12. Preferences of the user are entered into the data store 46. The preference unit 20 can retrieve the user preferences. For example, a user can prefer to receive an alert regarding chemical plant explosions. If an alert is issued for a tornado, the alert is confirmed to be a preferred alert of the user in order to send a message regarding the alert to the user. The preferred alert can be confirmed at any time after the alert is obtained. In FIG. 4, the preferred alert is confirmed after the geocoded location is ascertained to match the geocoded area. If the alert is confirmed to be a preferred alert, the flow continues to process block 120. If the alert is not confirmed to be a preferred alert, the flow ends. A feature of the preference unit 20 of the memory 12 is that a preferred type of message can also be stored in the data store 46. Thus, if a user prefers messages by email, then the alert system 100 can store this preference so as to only send email messages regarding the preferred alert to the user's communication device 54.

At process block 120, the system 100 sends a message regarding a matched-preferred alert to a user. The user can be a subscriber to a commercial alert system. The sending unit 24 of the memory 12 converts the alert into a message that is communicated to the user's communication device 54 through network 50. For example, the message can be an email, text-to-voice, SMS, voice, audible sound, or visual image sent to the mobile phone of the user. Once the user receives the message, the user has full knowledge of the alert and can respond accordingly. If the user is in the area of a chemical plant explosion, the user can immediately act to leave the area, contact emergency personnel, contact family, etc. The method 101 thus allows a user to immediately respond to desired alerts in small amounts of time. The reduced time in communication of the alerts can save money and lives depending on the type of alert.

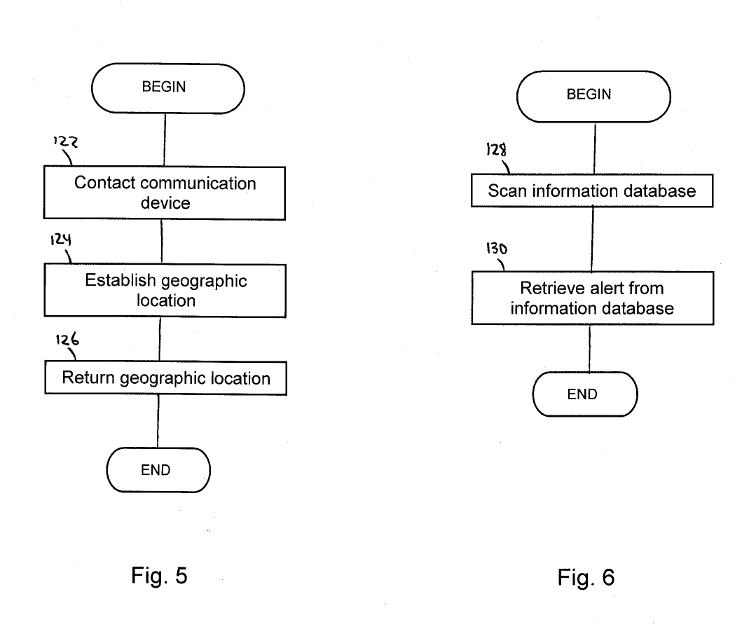

Referring to FIG. 5, there is shown a flow diagram for the step of acquiring of process block 102. That is, the step of acquiring in process block 102 is subdivided into other processes. The flow begins with process block 122. At process block 122, the system 100 contacts the communication device 54 through network 50. The contact information of the communication device 54 can be stored in the data store 46 so that the communication device 54 can be contacted at any time upon obtaining an alert. Contact can be made using the locating unit 18 of the memory 12. The flow continues to process block 124.

At process block 124, the geographic location of the global positioning system 56 of the communication device 54 is established. The geographic location can be established by the locating unit 18 of the memory 12. The GPS 56 calculates the position of the communication device 54. The locating unit 18 and the communication device 54 communicate to establish the geographic location. The flow continues to process block 126.

At process block 126, the geographic location is returned to the system 100 from the communication device 54. The locating unit 18 of the memory can return the geographic location. To return, the locating unit 18 can retrieve the location from the communication device 54 or the locating unit 18 can request the location and receive the location from the communication device 54. The flow for the step of acquiring ends. The overall flow continues to process block 104.

Referring to FIG. 6, there is shown a flow diagram for one embodiment of the step of obtaining of the method 101. This embodiment of the step of obtaining of method 101 begins with process block 128. At process block 128, the system 100 scans the information database 52 for alerts applicable to users of the system 100. The alert unit 14 of the memory 12 can scan the information database 52. The information database 52 can be any number and type of databases that issue and/or store alerts. The flow continues to process block 130.

At process block 130, the system 100 retrieves the alert from the information database 52. The alert unit 14 of the memory 12 can retrieve the alert. To retrieve, the system 100 affirmatively contacts information database 52 to request or inquire of alerts. The flow of this embodiment of the step of obtaining ends. The overall flow continues to process block 112.

Referring to FIG. 7, there is shown a flow diagram for another embodiment of the step of obtaining. This embodiment of the step of obtaining of method 101 begins with process block 132. At process block 132, the system 100 receives an alert from the information database 52. As stated above, the information database 52 can be any number/type of databases the issue/produce alerts. In this embodiment of the step of obtaining, the system 100 passively awaits the delivery of an alert from an information database 52. The flow of this embodiment of the step of obtaining ends. The overall flow continues to process block 112.

Referring to FIG. 8, there is shown a flow diagram for the step of sending. The step of sending begins with process block 134. At process block 134, the system 100 transmits a message to the communication device 54 of the user of the system 100 when the applicable geographic area of said alert matches geographic location. The message can be an email, text-to-voice, SMS, voice message, video image, audible sound, etc., that is adequate in communicating the alert to the user. A feature of the preference unit 20 of the memory 12 is that a preferred type of message can be stored in the data store 46. Thus, if a user prefers messages by email, then the alert system 100 can send only email messages regarding the alert to the user's communication device 54. Thus, a preferred message type can be transmitted to the communication device 54 of the user. The message can be transmitted by the sending unit 24 of the memory 12. The flow continues to process block 136.

At process block 136, the system 100 transfers the message to the communication device 54 through a wireless network. That is, the sending unit 24 of the memory 12 can transfer the message to the communication device 54 through the network 50, which is a wireless network. If the communication device 54 is a mobile phone, then the wireless network is most likely a mobile phone network using mobile phone signal technology. The flow for the step of sending ends. The overall flow of the method 101 also ends once the message is sent to the user.

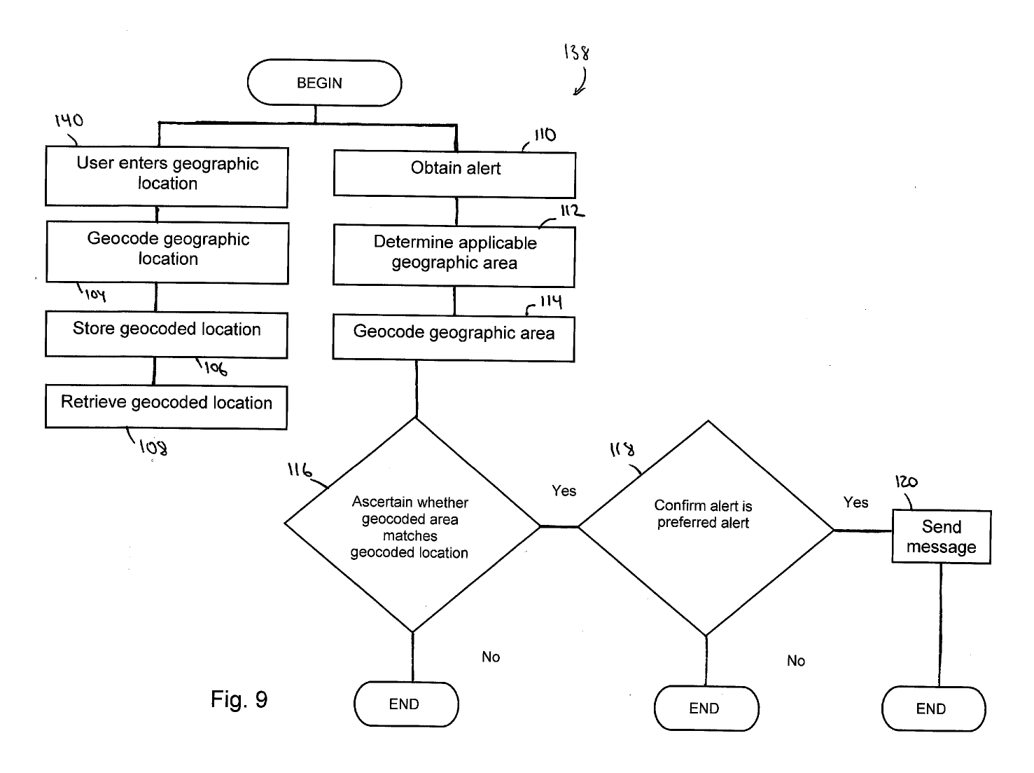

Referring to FIG. 9, there is shown a flow diagram for an alternative method 138 of alerting users of the geocoded alert system 100. The method 138 is similar to the method 101 discussed in FIG. 4 above except that the process block 102 for acquiring a geographic location in FIG. 4 is replaced with process block 140 in FIG. 9. In process block 140, the user of the alert system 100 enters a geographic location from a communication device of the user. The communication device can be a phone, mobile or cell phone, computer, or other device by which the user can communicate a geographic location to the system 100. The remaining process blocks 104 through 120 in the method 138 shown in FIG. 9 are similar to the process blocks 104 through 120 of the method 101 shown in FIG. 4. The method 138 allows a user of the alert system 100 to manually enter location data that is then retained and geocoded in the system 100 for communication of alerts.

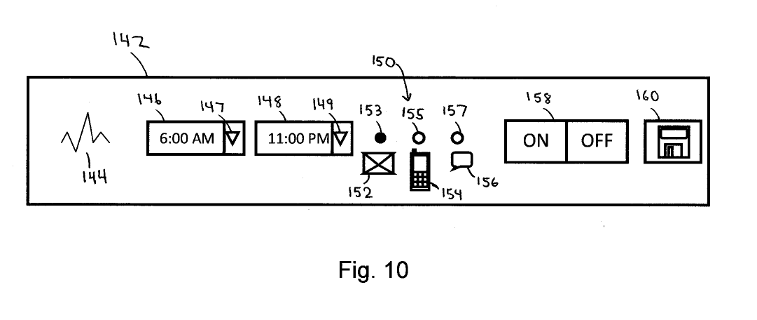

Referring to FIG. 10, there is shown a user interface 142 for the preference unit 20 of the system 100. The user interface 142 allows a user of the system 100 to manually enter preferences into the preference unit 20. The user interface 142 shows various preferences of the preference unit 20: an alert source 144, a start time 146 for which the alert can be communicated to the user of the system 100, an end time 148 for which the alert can be communicated to the user of the system 100, a method of contact 150, an alert status 158, and a save button 160 by which the user can save preferences to the preference unit 20. The particular alert source 144 shown in FIG. 10 is an earthquake alert; however, the invention contemplates that any type of alert can be used in the user interface 142. The start and end times 146 and 148 of the user interface 142 are the times during which a user prefers to be contacted in the event of a preferred alert. In FIG. 10, the user prefers to receive an alert from 6:00 AM to 11:00 PM daily. Thus, from 11:00 PM to 6:00 AM the user will not receive alerts from the system 100. Drop down button 147 for the start time 146 and drop down button 149 for the end time 148 allow the user to adjust the times to receive alerts. The user interface 142 allows a user to choose a time frame for daily receipt of alerts. The user interface could also include options for choosing, the days, weeks, months, etc. for receiving alerts.

Three methods of contact 150 are shown in FIG. 10. The user can choose to be contacted by email 152, shown by the letter icon, by SMS 154, shown by the mobile-phone icon, or by text-to-voice 156, shown by the caption bubble icon. The radio button 153 for email 152 is selected, while the radio button 155 for SMS 154 and the radio button 157 for text-to-voice 156 is are not selected, so the user of the user interface 142 prefers to only be contacted by email 152. Other methods of contact or communication can be included in the user interface 142, and the user can choose any combination of methods of contact or communication. In FIG. 10, the user has the ability to turn all communications of alerts on or off with the alert status 158. The alert status 158 of the user interface 142 is set to “on.” Once a user chooses the various preferences in the user interface, the user clicks on the save button 160 in order to save the preferences in the system 100.

By choosing preferences in the user interface 142 of the preference unit 20, the user's preferences are stored in the system 100 so that the system can determine whether an alert is a preferred alert. For FIG. 10, the user will receive an earthquake alert by email from the hours of 6:00 AM to 11:00 PM. The user can modify these preferences at any time and can have any number of other available alerts with respective preferences saved at any given time.

Using the disclosed methods 101 and 138, the user chooses preferences of whether to receive a type of alert. An alert can be communicated to a user regardless of whether the user is physically located within the applicable geographic area of the alert. For example, a user can have a permanent home location A and be in location B for a business trip. Locations A and B can be manually entered by the user or can be acquired by the system 100 using a communication device of the user. Thus, the method allows location A of a user to be used to determine whether to send an alert to the user regardless whether the user is in location A or in location B. If the user is at location A and an alert is received for location A, then the user receives the alert, as long as it is a preferred alert. If the user plans to go on a trip to location B and would like to receive alerts for location B, the user can enter location B in the system 100 and choose preferred alerts of location B to receive while the user is in location A. If the user goes on a business trip to location B, the user can either maintain alerts for location A or elect to turn off the alerts for location A, all while receiving alerts at communication devices at either or both locations A and B. Moreover, the user can choose to receive alerts in location B for only location B.

The foregoing description is illustrative and explanatory of the disclosed embodiments. Various changes can be made to the embodiments without departing from the spirit and scope of the invention. Therefore, the invention should be limited only by the following claims and their legal equivalents.

I claim:

1. A method for alerting a user of a geocoded alert system comprising:
obtaining an alert from an information database;
determining an applicable geographic area of said alert;
acquiring a geographic location from a communication device;
geocoding said geographic location into a geocoded location;
ascertaining whether said geocoded location matches said applicable geographic area of said alert; and
sending a message to said communication device.

2. The method of claim 1, said communication device having a global positioning system associated therewith.

3. The method of claim 2, said step of acquiring comprising:
contacting said communication device;
establishing said geographic location of said global positioning system of said communication device; and
returning said geographic location from said communication device.

4. The method of claim 1, said step of ascertaining comprising:
geocoding said applicable geographic area of said alert into a geocoded area; and
determining whether said geocoded location matches said geocoded area.

5. The method of claim 1, said step of sending comprising:
transmitting said message to said communication device when said applicable geographic area of said alert matches said geographic location.

6. The method of claim 1, further comprising:
confirming a preference to receive said alert.

7. The method of claim 6, said step of transmitting comprising:
transmitting said message to said communication device of the user when said alert is a preferred alert.

8. The method of claim 1, said step of obtaining comprising:
scanning said information database for said alert; and
retrieving said alert from said information database.

9. The method of claim 1, further comprising:
storing said geocoded location in a data store; and
retrieving said geocoded location from said data store when said alert is obtained.

10. The method of claim 1, said step of obtaining comprising:
receiving said alert from said information database.

11. A method for alerting a user of a geocoded alert system comprising:
obtaining an alert from an information database;
determining an applicable geographic area of said alert;
entering a geographic location by the user;
geocoding said geographic location into a geocoded location;
ascertaining whether said geocoded location matches said applicable geographic area of said alert; and
sending a message to a communication device of the user.

12. The method of claim 11, said step of ascertaining comprising:
geocoding said applicable geographic area of said alert into a geocoded area; and
determining whether said geocoded location matches said geocoded area.

13. The method of claim 12, said step of sending comprising:
transmitting said message to said communication device of the user when said geocoded area matches said geocoded location.

14. The method of claim 13, further comprising:
confirming a preference to receive said alert.

15. The method of claim 14, said step of sending further comprising:
transmitting said message to said communication device of the user when said alert is a preferred alert.

16. A memory for a geocoded alert system comprising:
an alert unit to obtain an alert, said alert having an applicable geographic area;
a locating unit to obtain a geographic location of a communication device;
a geocoding unit to geocode said geographic location into a geocoded location;
an analyzing unit to determine whether said geocoded location matches said applicable geographic area; and
a sending unit to send a message to said communication device when said geocoded location matches said applicable geographic area.

17. The memory of claim 16, further comprising:
a preference unit to determine whether said alert is a preferred alert, said sending unit to send said message only if said alert is said preferred alert.

18. The memory of claim 16, said geocoding unit to geocode said applicable geographic area into a geocoded area.

19. The memory of claim 18, said analyzing unit to determine whether said geocoded location matches said geocoded area.

20. The memory of claim 19, said sending unit to send said message to said communication device when said geocoded location matches said geocoded area.
